(19) United States
(12) Patent Application Publication
(10) Pub. No.: US 2005/0155235 A1
(43) Pub. Date: Jul. 21, 2005

(54) Inside/outside scribe

(76) Inventor: Robert Thomas Allen, Vancouver (CA)

Correspondence Address: Rob Allen, 3179 E. 16th Ave., Vancouver, BC, V5M2M6, CA

(21) Appl. No.: 11/077,617

(22) Filed: Mar. 11, 2005

Related U.S. Application Data
(63) Continuation-in-part of application No. 10/615,940, filed on Jul. 10, 2003.

(51) Int. Cl. B43L 13/02

(52) U.S. Cl. 33/42

(57) ABSTRACT

The invention is an improved, hand-held, adjustable, graduated marking gauge and scribe for carpentry and related activities. It is used to mark work-pieces at a given distance from an adjacent edge or intersecting surface such as is encountered when fitting cabinets or trim to uneven wall surfaces, or in the spiling of boat planking or the marking of cut-outs relative to an edge. The device consists of a main body, upon which are marked scales and which is bent and formed at one end to create an edge follower and a corner follower and upon which is mounted a sliding and stoppable instrument holder which holds marking, cutting or other instruments, inserted therein, in an adjustable fashion. The displacement of the centre-line of the marking instrument relative to the edge follower or the corner follower is read on the scales at the corresponding cursor edge of the instrument holder.

### CROSS-REFERENCE TO RELATED APPLICATIONS

This application is a continuation-in-part of prior application Ser. No. 10/615,940, filed Jul. 10, 2003.

### STATEMENT REGARDING FEDERALLY SPONSORED RESEARCH DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND OF THE INVENTION

The invention is a response to the needs of carpenters, building trades technicians and others who need to mark or trim work pieces parallel to either an inside or outside edge. This is exemplified by the scribing process involved in fitting a counter top to an uneven wall or in marking out a border to be painted around the perimeter of a sign.

There are many tools on the market which perform either inside edge marking, scoring or cutting functions, such as the “Adjustable gauge”, U.K. Patent number GB2197614, invented by Cryan; Henry Joseph or the tradiditional log scribe type. There are outside edge marking, scoring and cutting tools such as the “Scoring Devise With Edge Guide”, U.S. Pat. No. 4,030,195, invented by Insolio; Thomas A. and other traditional mortise gauge type tools. The Inside/Outside Scribe offers the user both inside corner and outside edge marking, scoring and cutting abilty. The invention is also a tool that is compact, cost effective, conveneint and easy to use

### SUMMARY OF THE INVENTION

According to one aspect of the present invention there is provided a hand held scribing and gauging tool which has been designed for use by building trades workers to quickly perform marking, scoring or cutting tasks relative to inside comers, such as fitting cabinets or tiles to uneven walls or to mark work pieces relative to outside edges for such functions as blind fastening or painting borders. Marking, scoring or cutting instruments may be used in the tool to perform those functions. The chosen instument is placed in the instrument holder which slides along the body of the tool and is stopped at a given distance from the end of the tool which is either hooked over an edge or butted into a corner and moved along said corner or edge to produce a mark, score or cut line at the desired distance from the corner or edge.

### BRIEF DESCRIPTION OF THE DRAWINGS

An example of the present invention will now be described with reference to the accompanying drawings:

FIG. 1, Cross section of FIG. 2 at aa with thumbscrews aligned.

FIG. 2, Face view of inside/outside scribe body and instrument holder depicting an embodiment of the tool in which the scales are aligned to be read at the two cursor edges.

FIG. 3, Side view of body and end view of instrument holder with thumbscrews aligned.

FIG. 4, Side view of instrument holder with aligned thumbscrews.

FIG. 5, Top view of instrument holder without thumbscrews.

FIG. 6, End view of instrument holder with aligned thumbscrews.

FIG. 7, Bottom view of instument holder without thumbscrews.

FIG. 8. Face view of inside/outside scribe body and instrument holder depicting an embodiment of the tool in which the scales are aligned to be read at only one cursor edge.

### DETAILED DESCRIPTION OF THE INVENTION

Reference will now be made in detail to the present preferred embodiments of the invention, examples of which are illustrated in the accompanying drawings wherein like numerals indicate the same elements throughout the views. The invention disclosed herein may be practiced in embodiments in many different forms and it is understood that the present disclosure is an exemplification of the principles of the invention and does not limit the invention to the illustrated embodiments. Therefore, specific details disclosed herein are not to be interpreted as limiting, but rather as a basis for the claims and as a representative basis for teaching one skilled in the art to employ the present invention.

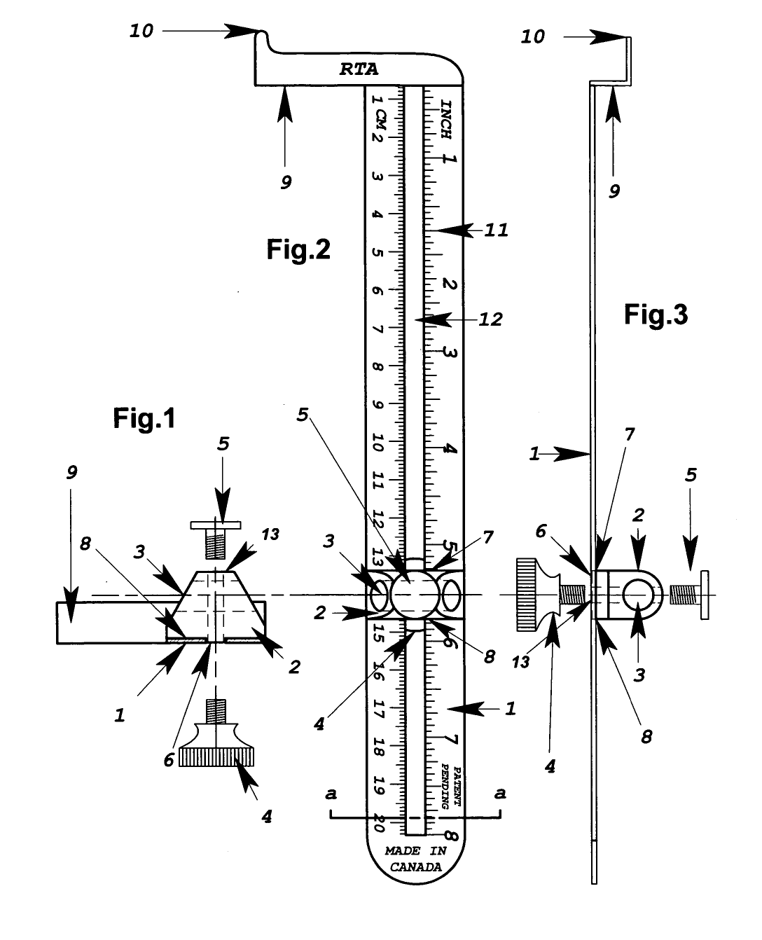

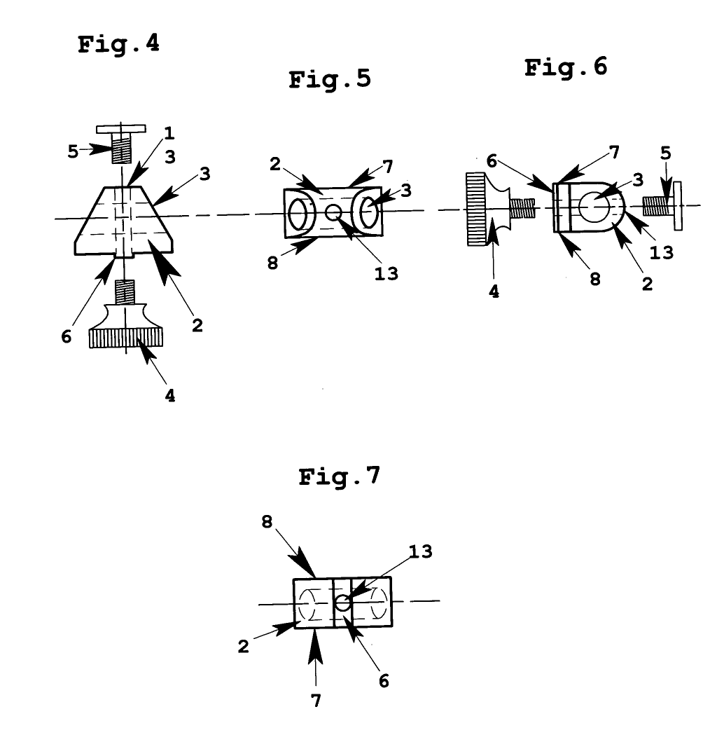

Referring to FIGS. 1, 2, 3, 4, 5, 6 and 7; In the advantageous embodiment of the inside/outside scribe, as seen in the drawings, the tool consists of an elongate body 1, made of a rugged material such as stainless steel, which is bent and formed at one end thereof, creating an edge follower 9, and a corner follower 10. Upon the body is mounted a sliding and stoppable instrument holder 2, made of suitable material, such as anodised aluminium, which holds, adjustably and releasably, by means of a thumbscrew 5, screwed into threaded hole 13, marking cutting or other instruments which are inserted through hole 3, and adjusted for intended use. Scales 11, are etched into and printed onto the face side of the body 1. The instrument holder 2, is slidably and stoppably mounted on the body 1, by means of a large, machined or cast metal or moulded polymer, (with inserted, threaded metal stud), shouldered thumbscrew 4, which passes through a slot 12, cut out of the body 1 and is screwed into threaded hole 13, of the instrument holder 2. The thickness of the instrument holder 2, is advantageously equal to the distance between the corner follower 10, and the edge follower 9, thereby creating a relationship between the far cursor edge 8, and the corner follower 10, whereby the distance from the corner follower 10, to the centre-line of an instrument being held in hole 3, of the instrument holder 2, can be directly read, adjacent to the far cursor edge 8, on the preferred, etched and inked scale 11, which is aligned to a plane which is at a right angle to the plane of the tool body and laying halfway between the edge follower 9, and the corner follower 10, and represents zero. A corollary relationship therefor exists between
the near cursor edge 7, and the edge follower 9, whereby the distance from the edge follower 9, to the centre-line of an instrument mounted in the instrument holder 2, may be directly read on the scale 11, adjacent to the near cursor edge 7. A nub 6, protrudes from the bottom of the instrument holder 2, which acts to align the instrument holder 2, in the slot 12, as it is mounted on the body 1. A plane formed by the centre-line of the held instrument and the corner follower 10, is roughly parallel to the main portion of the body, insuring relative accuracy of performance as the tool may be held at an approximate right angle to straight corners and edges and normal to curved corners and edges.

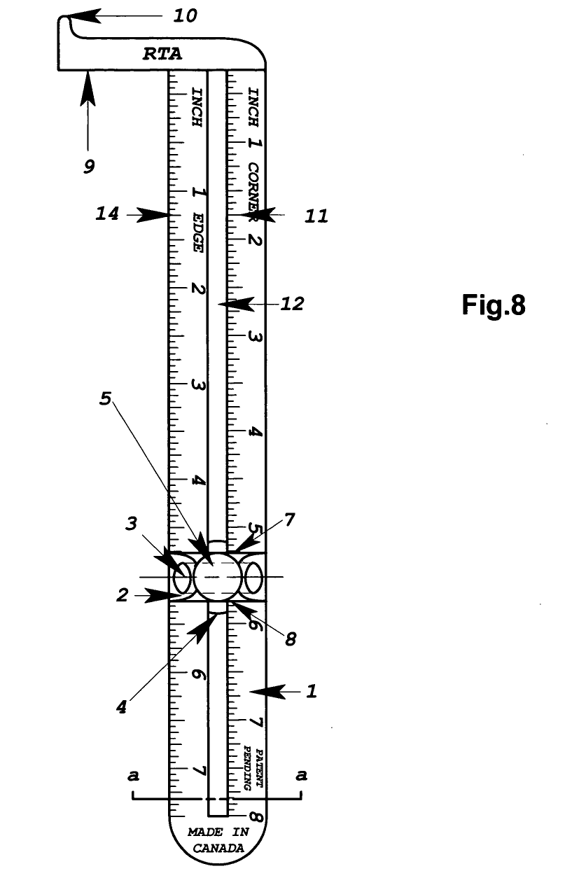

Referring to FIG. 8; In the alternatively advantageous imbodiment of the inside/outside scribe, as seen in the drawing, the tool is as described above with the exception that the zero plane of scale 14, is offset longitudinally from the zero plane of scale 11, by the same distance that the corner follower 10, is displaced longitudinally from the edge follower 9.

As will be apparent to those skilled in the art, various modifications and adaptations are possible in the practice of this invention without departing from the spirit or scope thereof. Accordingly, the scope of the invention is to be construed in accordance with the substance defined by the following claims.

1. A hand tool for scribing, marking or cutting materials, the tool comprising:
an elongate body;
an instrument holder which is slidably and stoppably mounted on the body; and
an analog member attached to one end of the body, the analog member comprising a corner follower and an edge follower whereby the tool is able to perform the dual functions of following either an inside corner or an outside edge

2. The tool as claimed in claim 1 wherein the corner follower is longitudinally displaced from the edge follower.

3. The tool as claimed in claim 2 further comprising a scale or scales of standard units of measure marked longitudinally on the elongate body from which may be determined the distance from either of the followers on the analog member to the centre line of an instrument held in the instrument holder during use of the tool.

4. The tool as claimed in claim 3 wherein the instrument holder further includes one cursor for indicating the distance between either of the followers on the analog member and the centre line of the instrument holder.

5. The tool as claimed in claim 4 wherein two or more scales are longitudinally displaced from each other on the elongate body a distance equal to the longitudinal displacemnt between the corner follower and the edge follower such that the single cursor may be used to read the distance between the centre of the instrument holder and either the corner follower or the edge follower.

6. The tool as claimed in claim 3 wherein the instrument holder further includes a near cursor for indicating the distance between the edge follower and the centre line of the instrument, and a far cursor for indicating the distance between the corner follower and the centre line of the instrument.

7. The tool as claimed in claim 6 wherein:
the near and far cursors are longitudinally displaced from each other in relation to the elongate body such that the near cursor is closer to the analog member than the centre line of the instrument, and the far cursor is farther from the analog member than the centre line of the instrument; and
the longitudinal displacement between the near and far cursors is equal to the longitudinal displacement between the corner and edge followers.

8. The tool as claimed in claim 7 wherein:
the scale is positioned longitudinally along the elongate body such that its zero index is, or would be if marked, between the corner follower and the edge follower;
the longitudinal distance between the edge follower and the zero index is equal to the longitudinal distance between the far cursor and the center line of the instrument; and
the longitudinal distance between the corner follower and the zero index is equal to the longitudinal distance between the near cursor and the center line of the instrument,
thereby allowing the user to read the position of the centre line of the instrument relative to either the inside or outside follower from the same scale.

9. The tool as claimed in claim 8 wherein the zero index is equidistant from the corner and edge followers.

10. The tool as claimed in claim 9 wherein the cursors are defined by respective edges of the instrument holder.

11. The tool as claimed in claim 10 wherein:
the elongate body is planar; and
the analog member and the center of the instrument are each offset from the plane of the elongate body.

12. The tool as claimed in claim 11 wherein the offset distance of the analog member is equal to the offset distance of the center of the instrument.
